(19) United States
(12) Patent Application Publication
(10) Pub. No.: US 2005/0091538 A1
(43) Pub. Date: Apr. 28, 2005

(54) Method, a network protection means, a network node, a network, and a computer software product for disinfection

(75) Inventors: Michael Walter Hoche, Schwieber-dingen (DE); Peter Szabo, Pforzheim (DE); Horst Rossler, Filderstadt (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/951,820

(22) Filed: Sep. 29, 2004

(30) Foreign Application Priority Data
Oct. 27, 2003 (EP) 03292680.0

(51) Int. Cl. H04L 9/32

(52) U.S. Cl. 713/201; 713/188

(57) ABSTRACT

The invention relates to a method for screening and disinfecting a communication network for viral infection, the communication network comprising interconnected network nodes and a designated network node, the method comprising scanning a plurality of data streams, detecting the presence of components of the computer virus at a designated network node with suitable detection means, applying suitable cure or protection means for ensuring an operative state in case of a virus detection, propagating the suitable cure or protection means and/or the suitable detection means to an originating network node of an infected data stream, receiving other suitable cure or protection means and/or the suitable detection means, curing the originating network node by applying the other suitable cure or protection means and/or the suitable detection means, if necessary, and propagating the other suitable cure or protection means and/or the suitable detection means to potential source network nodes (from which the virus could be received) and to potential target network nodes (where the virus could be distributed). The invention further relates to a network node, a communication network, a network protection means, and a computer software product.

### TECHNICAL FIELD

The present invention relates to a method for efficiently screening and disinfecting a communication network, and the invention relates to a corresponding network protection means, a network node, a communication network and a computer software product.

The invention is based on a priority application, EP 03292680.0, which is hereby incorporated by reference.

Due to the complexity of computer systems and (tele-) communication systems, as well as the (tele-) communication networks and the emerging techniques and developments in intruding systems, it is highly challenging to keep these systems operable.

### BACKGROUND OF THE INVENTION

There are many techniques known for keeping software driven systems operable. Such a technique is disclosed by U.S. Pat. No. 5,440,723. There a periodic monitoring of a data processing system for anomalous behavior is suggested that may indicate the presence of an undesirable software entity such as a computer virus, worm, or Trojan Horse by automatic scanning for occurrences of types of undesirable software entities and taking remedial action if they are discovered including informing neighboring data processing systems on a network of an occurrence of the undesirable software entity.

It is well known that virus protection means like virus patterns are deployed continuously in order to enable a disinfection system to recognize infections and to apply the corresponding treatment. The deployment of software portions, especially of virus protection means is solved by a system comprising self-updating clients, realized by a managed update procedure using a network connection to a supporting server, which is e.g. known from U.S. Pat. No. 6,067,351.

Contrary there are self-distributing pieces of software known like the Code Red virus. This virus was one of the first of a family of new self-propagating malicious codes that exploits network systems. The Code Red worm is a self-replicating malicious code that exploits a vulnerability in several servers and routers. A worm attack proceeds as follows. The virus attempts to connect to a randomly chosen host assuming that a web server will be found. Upon a successful connection the attacking host sends a crafted HTTP GET request to the victim, attempting to exploit a buffer overflow in an indexing service. The same exploit (HTTP GET request) is sent to each of the randomly chosen hosts due to the self-propagating nature of the worm.

Depending on the configuration of the host which receives this request, there are varied consequences, e.g. when the exploit is successful, the worm begins executing on the victim host. In addition to possible web site defacement, infected systems may experience performance degradation as a result of the scanning activity of this worm. This degradation can become quite severe since it is possible for a worm to infect a machine multiple times simultaneously. Non-compromised systems and networks that are being scanned by other infected hosts may experience severe denial of service. Furthermore, while the Code Red worm appears to merely deface web pages on affected systems and attack other systems, the indexing vulnerability it exploits can be used to execute arbitrary code in the local system security context. This level of privilege effectively gives an attacker complete control of the victim system.

Virus scanner and disinfecter, system monitors that disinfects client systems today are well known. Another virus protection method is a consistent separation of potential virus sources. The current security-best-practice is restricting or denying network traffic and only selectively allowing portions that are really required and clean, e.g. enforced by ingress and egress filtering, implemented at the network edge or boundary, typically at a firewall.

When a system becomes infected, the systems may experience performance degradation as a result of the scanning activity of the virus/worm or the cure. This degradation can become quite severe since it is possible for a virus/worm to infect a machine multiple times, even simultaneously, especially the aforementioned firewalls become a performance bottleneck.

Currently getting rid of a worm sometimes requires even to de-couple the infected network nodes systematically from the network until the whole network is clean.

Due to the exponential distribution behavior of a virus infection, the caused system degradation, and propagating (network) malfunctions, there is a need for a fast, more efficient and practicable cure. Fast means the virus is eliminated (at) once. Efficient means using few resources, only, at least no long term degradation, and practicable means self-organized or automatically.

### SUMMARY OF THE INVENTION

This problem is solved by a method for screening and disinfecting a communication network for viral infection, where the communication network comprising interconnected network nodes and at least one designated network node, the network nodes comprising an operative software system, the method comprising
scanning a plurality of data streams,
detecting the presence of components of the computer virus at a designated network node with suitable detection means,
applying suitable cure or protection means for ensuring an operative state in case of a virus detection,
propagating the suitable cure or protection means and/or the suitable detection means to an originating network node of an infected data stream,
receiving other suitable cure or protection means and/or the suitable detection means,
curing the originating network node by applying the other suitable cure or protection means and/or the suitable detection means, if necessary, and
propagating the other suitable cure or protection means and/or the suitable detection means to potential source network nodes (from which the virus could be received) and to potential target network nodes (where the virus could be distributed).

The problem is solved inter alia by a network protection means residing at a network node, the network protection means comprising scanning means for scanning a plurality of data streams, detecting means for detecting the presence of components of the computer virus at the network node with suitable detection means and cure or protection means for ensuring an operative state in case of a virus detection, where the network protection means comprises communication means for propagating the suitable cure or protection means and/or the suitable detection means to an originating network node of an infected data stream, and communication means for receiving other suitable cure or protection means and/or the suitable detection means, the network protection means further comprising execution means for curing the originating network node by applying the other suitable cure or protection means and/or the suitable detection means, if necessary, the communication means being formed in such a way that the other suitable cure or protection means and/or the suitable detection means are propagated to potential source network nodes (from which the virus could be received) and to potential target network nodes (where the virus could be distributed).

And the problem is solved by a network node with such a network protection means, or a communication network comprising such interconnected network nodes and at least one designated network node, the network nodes. The network protection means is preferably implemented as a computer software product.

In short, the invention is a cure (anti virus, anti worm) deployment pattern, where each infection is traced back (and forward) systematically to the originators where each node on the backward path is cured.

A virus or worm is distributed from an originator in waves of infections. When a network node detects an infection, the network node applies the cure. It knows from where the infection is coming and provides means to cure the originator. A network node receiving a cure means applies the cure means (if necessary) and provides these means recursively to potential infected network nodes, originators as well as targets.

This will result in a very quick distribution of the required cure to a dedicated (dynamically determined) set of infected network parts.

Accordingly, it is an advantage of the present invention to provide fast and effective distribution of a virus cure within a communication network.

Another advantage of the present invention is the increased (embedded) security and protection of a network yielding a higher overall reliability.

A further advantage of the present invention is the improved repair efficiency and overall networking performance.

Yet another advantage of the present invention is that the invention provides a method with an advanced deployment pattern that can even cope with worms and communication network degradations. The automatic cure requires no management or maintenance activities. It is easy to implement e.g. by integrating the method into dedicated servers, e.g. firewalls or special protection servers, or even network elements like routers.

These and many other objects and advantages of the present invention will become apparent to those of ordinary skill in the art from a consideration of the drawings and ensuing description.

### BRIEF DESCRIPTION OF THE DRAWINGS

FIG. 1 is a schematic drawing of a prior art communication network.

FIG. 2 is a schematic drawing of a prior art communication network illustrating the spreading of a virus.

FIG. 3 is a drawing of a trace illustrating the spreading of a virus in a prior art communication network.

FIG. 4 is a drawing of a trace illustrating the spreading of a virus with identified distribution paths identified by the method according to the invention.

FIG. 5 is a drawing of a trace illustrating the spreading of a virus and the distribution of cure means by the method according to the invention.

### DETAILED DESCRIPTION OF THE INVENTION

Currently there is a trend in computer science to solve problems using nature-analogous methods, e.g. neuronal networks, genetic algorithms etc. The corresponding biological object to this invention is an immune system comprising among others especially antibodies.

An immune system is a complex network of specialized cells and organs that work together to defend the body against attacks by “foreign” invaders such as bacteria or viruses. It produces antibodies, a protein, in response to an antigen (often a virus or bacterium). It is able to neutralize the antigen. An antibody is one of various bodies or substances in the blood which act in antagonism to harmful foreign bodies, as toxins or the bacteria producing the toxins. Normal blood serum apparently contains various antibodies, and the introduction of toxins or of foreign cells also results in the development of their specific antibodies. “Antibody-forming cells,” which are called B cells or plasma cells are dedicated to produce secreted antibodies.

The existence of a method for identifying viruses enables a network node propagating the knowledge about a virus with something like an antibody to that virus. Removing humans from the protection process cuts the response time to a new virus from several days or even several weeks to a few hours or less. The main difficulty with today's method of updating scanners is that the distribution mechanism for signature updates is often slow, inefficient, and uncertain.

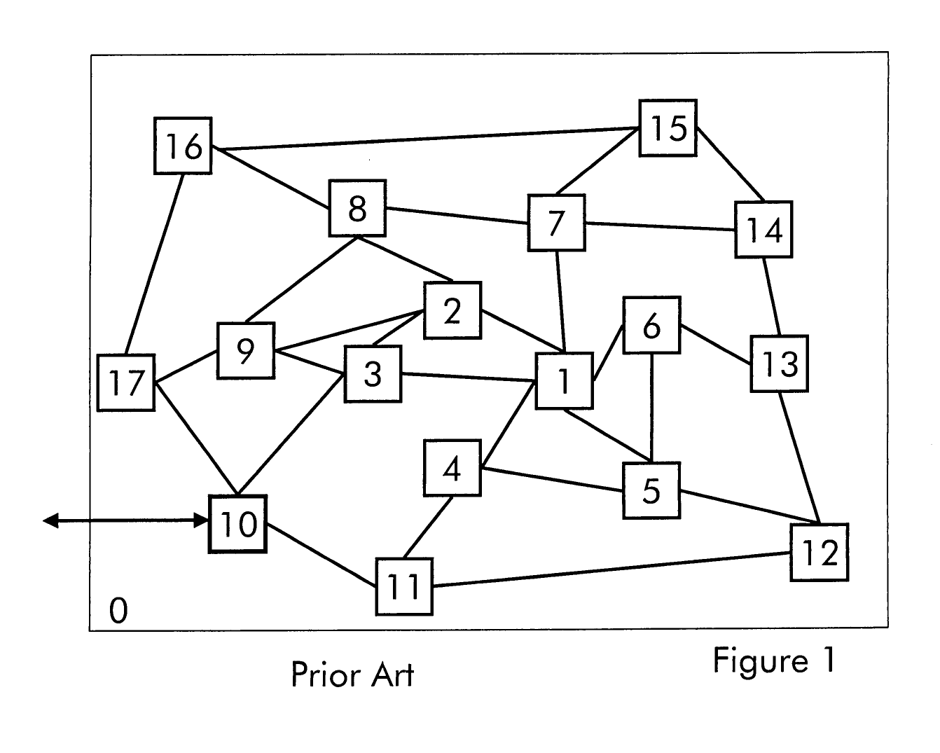

FIG. 1 shows a communication network 0 of interconnected network nodes 1, 2, 3, . . . , 17, e.g. computers, gateways, switches, hubs, bridges, etc. There is a gateway network node 10, e.g. a firewall connecting the communication network 0, e.g. a virtual private network or a sub-network, with a foreign communication network, illustrated by the double arrow.

Let formally the set of network nodes be V and the set of inter-connections be E, a subset of V×V. Further assume that the connections are bi-directional (for simplicity), i.e. E is symmetric. The showed communication network in FIG. 1 corresponds to the structure
V={1, 2, 3, 4, 5, 6, 7, 8, 9, 10, 11, 12, 13, 14, 15, 16, 17}
E={[1,2],[1,3],[1,4],[1,5],[1,6],[1,7],[2,3],[2,8],[2,9][3,9], . . . ,[16,17]}

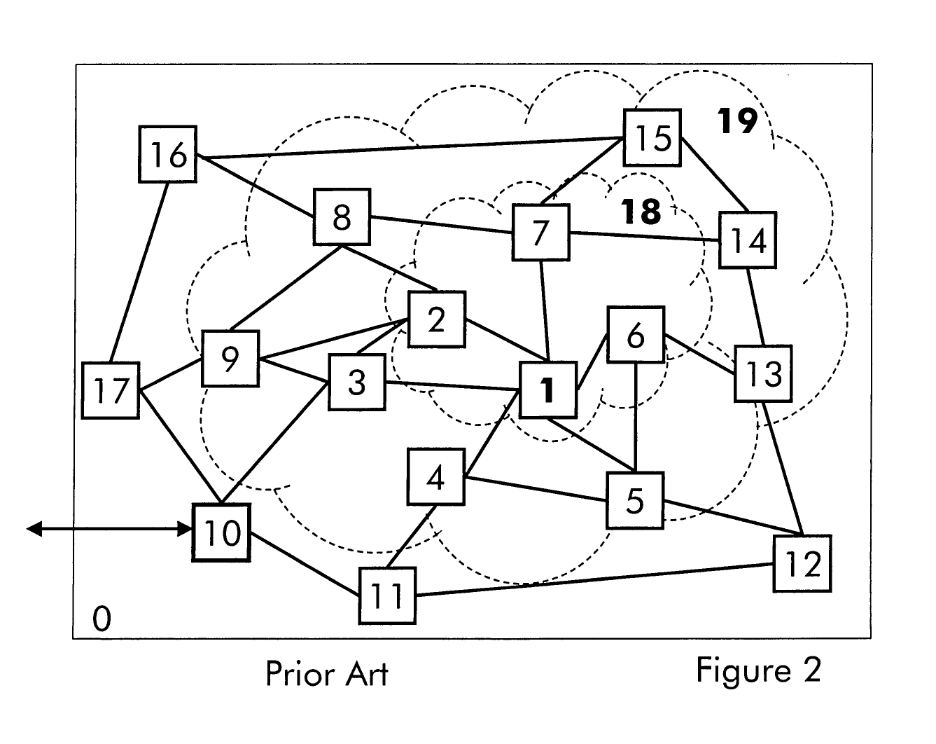

FIG. 2 shows now how an infection propagates through the communication network 0. The infection starts at an origin network node 1, propagates in a first wave 18 comprising the network nodes 2, 6, and 7. In a further wave 19, the network nodes 3, 4, 5 ,8, 9, and 13, 14, 15 are infected via the corresponding interconnections e.g. [1,2], [1,6], [1,7], for the first wave and [2,8], [1,3], [1,4], [1,5], [6,5], . . . for the second wave.

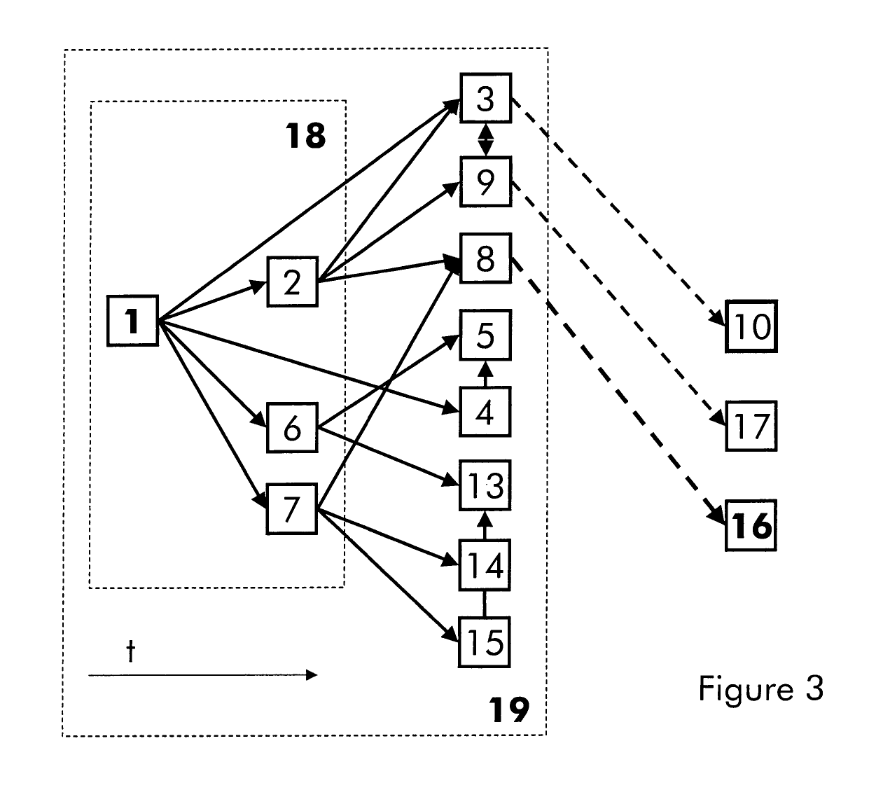

The propagation (infection) is shown in a trace diagram, FIG. 3. This is a diagram which illustrates the time line t of the above infection process. The vertices 1, 2, 3, . . . , 17 in the diagram correspond to network nodes although they could occur several times. They could be uniquely identified by mentioning the occurrence number, e.g. the first occurrence of vertex 3.

The diagram illustrates the infection process in a discrete time domain. Beginning at vertex 2 the virus is propagated via the edges [1,2], [1,6], and [1,7]; infecting the network nodes 3, 6, and 7 within the first wave 18. The next snapshot shows the infection of the network nodes 3,4,5,8,9,13,14,15 via the corresponding edges [1,3][1,4],[2,3],[2,8],[2,9],[6,5], . . . Note that a network node could even be infected twice, e.g. the network node 3. At each time a set of infections is processed which could be presented by a set of origin-target-pairs via an edge. That means each infection corresponds one-to-one to a time indexed edge.

The time induces a kind of order, illustrated by arrows in the trace diagram, which justifies the terms backward propagation and forward propagation. The set of network nodes from which a virus has originated at a certain network node forms an ideal that is generated by the corresponding vertex in the trace order that separates a potential set of infected network nodes. Simply all infected network nodes (vertices) that are before the corresponding vertex.

In the future network node 1 7 will be infected from network node 8 which is illustrated by the dashed arrow between the aforementioned network nodes.

Suppose that all network nodes are equipped with a network protection means according to the invention, and network node 17 scans an infecting (incoming, from network node 8 originated) data stream, detects the presence of a computer virus and applies suitable cure or protection means for ensuring an operative state, i.e. it is the designated network node in the claimed method according to the invention.

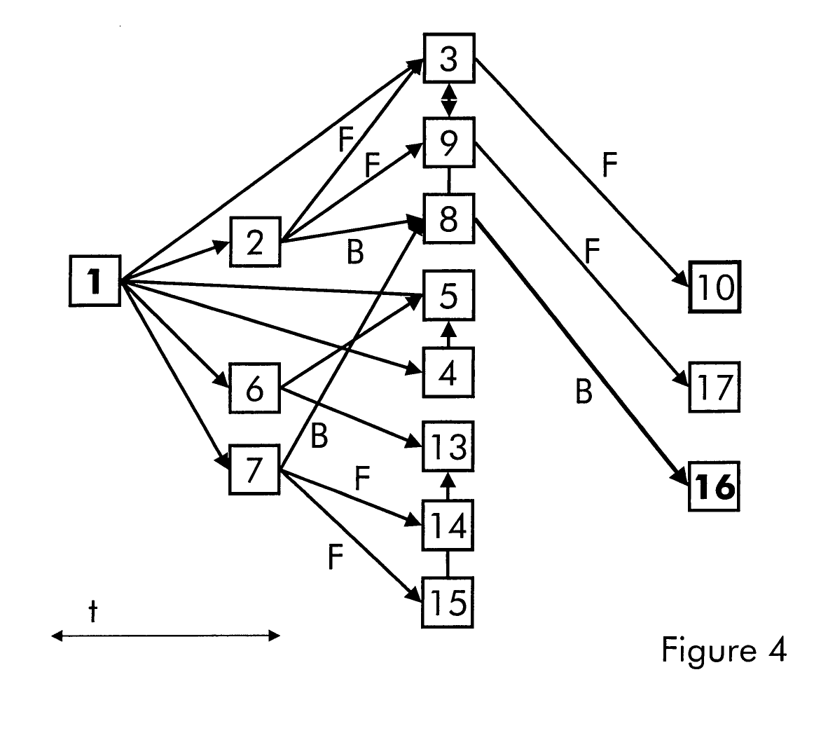

In a further step the designated network node will propagate the suitable cure or protection means and/or the suitable detection means to an originating network node of an infected data stream, which is in the example the network node 8. This fact is Illustrated in FIG. 4.

The network node 8 will be cured recursively by receiving the (other) suitable cure or protection means and/or the suitable detection means, illustrated by the “B” at the arrow presenting the infection of the designated network node 16, and will cure itself (the originating network node) by applying the (other) suitable cure or protection means and/or the suitable detection means, since it is necessary.

Suppose the local infection history is present at each network node. Then the cured network node 8 will propagate back the (other) suitable cure or protection means and/or the suitable detection means to potential source network nodes (from which the virus could be received), which are the network nodes 2 and 7.

These network nodes 2 and 7 will proceed with the disinfection according to the claimed method. I.e. receiving the suitable cure or protection means and/or the suitable detection means, curing the originating network node by applying the other suitable cure or protection means and/or the suitable detection means, since it is necessary, and propagating the suitable cure or protection means and/or the suitable detection means to potential source network nodes (from which the virus could be received), which is e.g. in the case of network node 2 the network node 1, and propagated forward to potential target network nodes (where the virus could be distributed) which are in the case of network node 2 the network nodes 3 and 9.

The ideal induced by a vertex with respect to the inverse order, like vertex 8, is also a set of potential infected nodes. To limit the procedure these network nodes have to check for an infection in order to limit the propagation.

This game continues until the network is disinfected. The forward propagating and the backward propagating ensures that all infected network nodes are reached by the cure and avoids a disinfection of non-infected network parts.

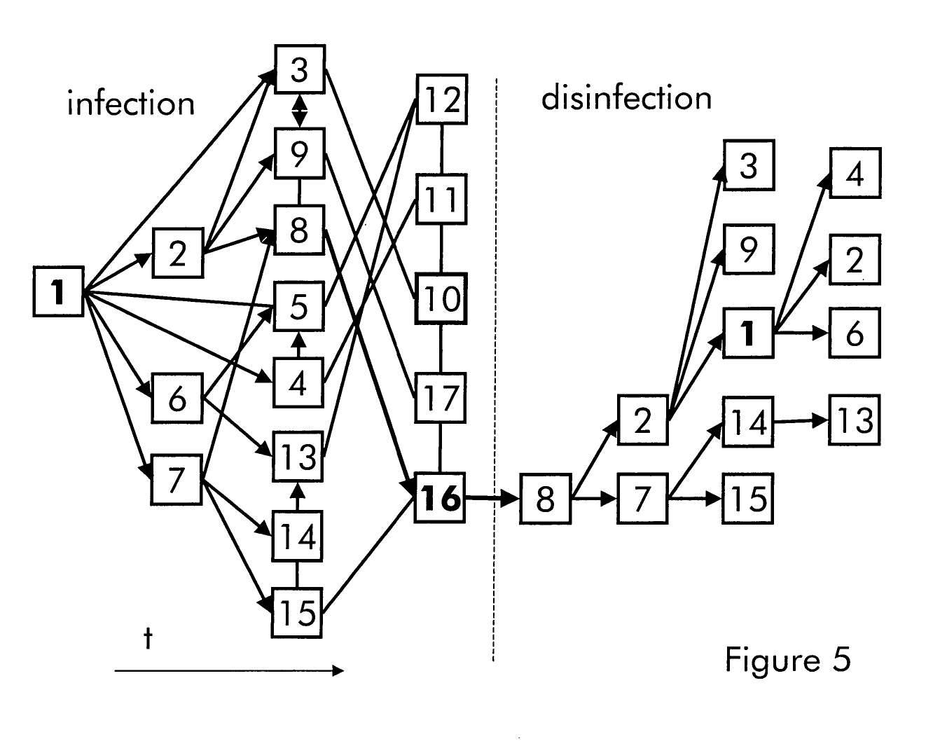

The disinfection trace is illustrated in FIG. 5. There the disinfection process is unfolded analogous to the infection process.

A semi formal denotation of an algorithm could be

Procedure NETWORK_PROTECTION_MEANS

Continuously
Log incoming data streams
Scan incoming data streams for known virus patterns
In case of a detection
apply a corresponding cure
retrieve the (possible) originators from the log
inform the originators about the infection, the virus pattern, and the cure

Continuously
Listen for infection information
In case of a received virus pattern and the cure
Validate the infection using the virus pattern
In case of an infection
apply a corresponding cure
retrieve the (possible) originators and targets from the log
inform the (possible) originators and targets originators about the infection, the virus pattern, and the cure

Although this algorithm could be implemented in silicon a preferred embodiment is to realize it as a computer software product.

Since scanning for viruses with a large set of virus pattern is resource consuming it is suggested to maintain the set of virus patterns, i.e. to drop some patterns e.g. virus patterns corresponding to outdated techniques or viruses that attack applications that are not present etc.

For maintaining the log as well as the virus pattern set efficient hashing techniques are suggested. The logged history could be limited to the propagation time towards the whole network even without losing the completeness and correctness of the above algorithm.

The invention is a refined principle of fighting self-replication with self-replication. When a computer detects a virus, it eliminates the infection, immunizes itself against future infection, and informs its neighbors, more efficiently the potential set of infected neighbors.

In summary: In biology there are certain cells, or organs carrying the infection. Today's communication networks with network nodes like computers lack a cellular topology corresponding to organs. Therefore, another method of limiting the replication is needed: one based on the history of infection. The detection of a virus by a single computer can trigger a wave of antibodies that propagates along the path taken by the virus, and combat the virus in its trace.

The immune system would monitor a network node for suspicious, virus-like behavior or virus patterns itself. Periodic scans for known viruses would take place. Any infections attributable to known viruses would be eliminated by repairing or restoring the infected host programs and the knowledge would be forwarded—protecting the operability of each network node in a communication network as well as the overall performance.

To enforce the method according to the invention throughout a communication network, it is even suggested to encapsulate the suitable cure or protection means and/or the suitable detection means like a retro-virus in order to enforce the distribution. That means the originator even does not need to have an installed operable virus protection means according to the invention for receiving, applying, or propagating. Instead the capsule could be implemented as a virus also carrying the propagation strategy, e.g. the above described algorithm.

1. A method for screening and disinfecting a communication network for viral infection, the communication network comprising interconnected network nodes and at least one designated network node, the network nodes comprising an operative software system, the method comprising
scanning a plurality of data streams,
detecting the presence of components of the computer virus at a designated network node with suitable detection means,
applying suitable cure or protection means for ensuring an operative state in case of a virus detection, wherein
the suitable cure or protection means and/or the suitable detection means is/are propagated to an originating network node of an infected data stream,
other suitable cure or protection means and/or suitable detection means is/are received,
the originating network node is cured by applying the other suitable cure or protection means and/or the suitable detection means, if necessary, and
the other suitable cure or protection means and/or the suitable detection means is/are propagated to potential source network nodes (from which the virus could be received) and to potential target network nodes (where the virus could be distributed).

2. The method according to claim 1, wherein said method comprises a further step of removing cure or protection means and/or detection means after the curing and propagating.

3. The method according to claim 1, wherein said method comprises a further step of maintaining a history of curings, propagations, or infections.

4. A network protection means resided at a network node, the network protection means comprising scanning means for scanning a plurality of data streams, detecting means for detecting the presence of components of the computer virus at the network node with suitable detection means and cure or protection means for ensuring an operative state in case of a virus detection, wherein the network protection means comprises communication means for propagating the suitable cure or protection means and/or the suitable detection means to an originating network node of an infected data stream, and communication means for receiving other suitable cure or protection means and/or the suitable detection means, the network protection means further comprising execution means for curing the originating network node by applying the other suitable cure or protection means and/or the suitable detection means, if necessary, the communication means being formed in such a way that the other suitable cure or protection means and/or the suitable detection means are propagated to potential source network nodes (from which the virus could be received) and to potential target network nodes (where the virus could be distributed).

5. The network protection means according to claim 4, wherein said network protection means comprises control means for removing cure or protection means and/or detection means after the curing and propagating.

6. The network protection means according to claim 4, wherein said network protection means comprises control means for maintaining a history of curings, propagations, or infections.

7. A network node with a network protection means, the network protection means comprising scanning means for scanning a plurality of data streams, detecting means for detecting the presence of components of the computer virus at the network node with suitable detection means and cure or protection means for ensuring an operative state in case of a virus detection, wherein the network protection means comprises communication means for propagating the suitable cure or protection means and/or the suitable detection means to an originating network node of an infected data stream, and communication means for receiving other suitable cure or protection means and/or the suitable detection means, the network protection means further comprising execution means for curing the originating network node by applying the other suitable cure or protection means and/or the suitable detection means, if necessary, the communication means being formed in such a way that the other suitable cure or protection means and/or the suitable detection means are propagated to potential source network nodes (from which the virus could be received) and to potential target network nodes (where the virus could be distributed).

8. A communication network comprising interconnected network nodes and at least one designated network node, the network nodes residing a network protection means, the network protection means comprising scanning means for scanning a plurality of data streams, detecting means for detecting the presence of components of the computer virus at the network node with suitable detection means and cure or protection means for ensuring an operative state in case of a virus detection, wherein the network protection means comprises communication means for propagating the suitable cure or protection means and/or the suitable detection means to an originating network node of an infected data stream, and communication means for receiving other suitable cure or protection means and/or the suitable detection means, the network protection means further comprising execution means for curing the originating network node by applying the other suitable cure or protection means and/or the suitable detection means, if necessary, the communication means being formed in such a way that the other suitable cure or protection means and/or the suitable detection means is/are propagated to potential source network nodes (from which the virus could be received) and to potential target network nodes (where the virus could be distributed), such that the suitable cure or protection means and/or the suitable detection means are deployed dedicated to infected network nodes.

9. A computer software product comprising programming means that are formed to perform the steps according to claim 1.
